(19) United States
(12) Patent Application Publication
(10) Pub. No.: US 2003/0079777 A1
(43) Pub. Date: May 1, 2003

(54) Apparatus for collecting and containing fluid

(76) Inventor: David Mitchell, Carina (AU)

Correspondence Address: HOFFMAN WASSON & GITLER, 2361 JEFFERSON DAVIS HIGHWAY, SUITE 522, ARLINGTON, VA, 22202

(21) Appl. No.: 10/268,689

(22) Filed: Oct. 11, 2002

(30) Foreign Application Priority Data
Oct. 26, 2001 (AU) PR8509

(51) Int. Cl. B67C 3/16

(52) U.S. Cl. 137/205

(57) ABSTRACT

An apparatus (1) for collecting and containing fluid from a reservoir of fluid. The apparatus (1) includes a container (2), an inlet (3) into the container (2) for fluid from the reservoir of fluid, a tap (5) operable between an open and a closed position for controlling flow of the fluid through the inlet (3), an outlet (11) from the container (2) that is attachable to a vacuum gun (25) for generating a vacuum within the container (2), and an outlet valve assembly (13) having a valve seat (14) and an outlet valve member (15) biased into engagement with the seat (14) and moveable out of engagement with the seat (14) when a vacuum is being generated in the container (2) by the vacuum gun (25). By generating a vacuum in the container (2) with the tap (5) closed, the container (2) may be detached from the gun (25) and used as a portable vacuum source.

### BACKGROUND OF THE INVENTION

This invention relates to an apparatus for collecting and containing fluid. In particular, the invention concerns an apparatus for vacuum extracting fluid from a reservoir of fluid and for containing the same.

Many types of machines require fluids to function. Vehicles, for instance, require engine oil, automatic transmission fluid, brake fluid, coolant and power steering fluid. Industrial machines, such as lathes and mills, require cutting fluid, and transformers require cooling fluid. It may be necessary to periodically remove or replace such fluids such that the machines are kept in good working order.

Apparatus for extracting fluids from machinery and for containing the same are known and typically employ vacuum pumps that are powered either by a source of compressed air (shop air) or by a mains power supply. In use, a hose or other type of fitting of such an apparatus is placed in contact with the fluid and a pump of the apparatus draws the fluid into a container of the apparatus by way of the hose. A disadvantage with such an apparatus is that it is largely restricted to use in the vicinity of shop air or a mains power supply, or if used at a remote location, then the apparatus requires a lengthy power cord and/or hoses.

### SUMMARY OF THE INVENTION

It is an object of the present invention to provide an apparatus for collecting and containing fluid that overcomes the disadvantage referred to above or provides the public with a useful or commercial choice.

According to the present invention there is provided an apparatus for collecting and containing fluid from a reservoir of fluid, said apparatus having:

a container;

an inlet into the container for fluid from the reservoir of fluid;

an inlet valve operable between an open and a closed position for controlling flow of the fluid through the inlet;

an outlet from the container attachable to a vacuum pump for generating a vacuum within the container; and,

an outlet valve assembly including a valve seat and an outlet valve member biased into engagement with the valve seat and moveable out of engagement with the valve seat when a vacuum is being generated in the container by the vacuum pump.

The outlet valve member may be of any suitable construction and may be located within any suitable interior region of the container. The outlet valve member may have a sealing end for engaging the valve seat and a valve stem extending from the sealing end. Preferably, the outlet valve member is a jumper valve.

The outlet valve member may be biased into engagement with the valve seat using any suitable biasing means. Preferably, a coil spring biases the sealing end into engagement with the valve seat. The coil spring may extend around the valve stem.

The valve seat may have one or more apertures extending therethrough. Preferably, the valve seat has a central aperture that is sealable with the sealing end. The sealing end preferably engages an upper surface of the valve seat.

The outlet valve assembly may include a guide for guiding the outlet valve member into and out of engagement with the valve seat. The guide may be of any suitable construction and may be located within any suitable interior region of the container. The guide may comprise a perforated disk and a guide sleeve extending perpendicularly from the disk, and the valve stem may slidably extend through the guide sleeve. The coil spring may extend around the valve stem between the sealing end of the outlet valve member and the guide.

The apparatus may further include a float valve assembly for closing the outlet when the container is full of the fluid. The float valve assembly may be of any suitable construction and may be located within any suitable interior region of the container. The float valve assembly may include a valve seat and a float valve member for engaging the valve seat. Preferably, the float valve member has a sealing end engagable with a lower surface of the valve seat of the outlet valve assembly and a buoyant body extends from the sealing end of the float valve member towards a bottom of the container.

The float valve assembly may include a housing for guiding the float valve member for movement relative to the valve seat. The housing may be of any suitable construction and may be located within any suitable interior region of the container. Preferably, the housing extends from the lower surface of the valve seat. The float valve member may have fins extending radially from an upper region of the buoyant body which are slidably retained within the housing and a lower region of the buoyant body may extend through a lower end of the housing. When a vacuum is being generated in the container by the vacuum pump, air located within the container may be drawn through the lower end of the housing, between the fins and through the outlet. When fluid fills the container, the float valve member may slide within the housing towards the valve seat.

The container may have a spherical body for containing the fluid and a ground-bearing stand that extends from the body. The container may have reinforcing ribs extending around the body for preventing the body from collapsing under vacuum.

The container may have a carry handle extending from an upper region of the body.

The container may have an inlet spout extending from the body and the inlet may be located at an end of the inlet spout.

The inlet valve may be any suitable type of valve known to persons skilled in the art. Preferably, the inlet valve is a tap. The apparatus may include a cap attachable to the inlet spout and the tap may be rotatably mounted to the cap.

The container may have an outlet spout extending from an apical region of the spherical body and the outlet may be located at a free end of the outlet spout.

The apparatus may further include an outlet sleeve attachable to the outlet spout. Preferably, the barrel of the vacuum gun as described in the specification of WO 01/60671 is attachable to a free end of the outlet sleeve. The barrel of the vacuum gun may be frictionally fitted to the outlet sleeve and the apparatus may include a compression nut for releasably securing the barrel to the outlet sleeve.

Preferably, the outlet valve assembly is located within the outlet sleeve and the float valve member extends from within the outlet spout into the spherical body.

The outlet sleeve may comprise two or more sleeve pieces attachable to one another. A first sleeve piece may be in the form of a cap that is attachable to the outlet spout. The valve seat and the float housing may be integrally formed with the first sleeve piece, and the guide of the outlet valve assembly may be integrally formed with a second sleeve piece. With this arrangement, the valve member of the outlet valve assembly and the float valve member may be accessed for repair or replacement.

The apparatus may further include a fitting, such as a hose fitting, that is attachable to the inlet valve. An end of the fitting may communicate with the reservoir of fluid and the other end of the fitting may be attachable to the inlet valve by way of a quick coupling device.

### BRIEF DESCRIPTION OF THE DRAWINGS

FIG. 1 is a part sectioned side elevation view of an apparatus for collecting and containing fluid, and the apparatus is shown attached to a vacuum gun, according to an embodiment of the invention;

FIG. 2 is an enlarged part sectioned view of part of the apparatus shown in FIG. 1; and

FIG. 3 shows side views of some of the fittings of the apparatus of FIG. 1.

### DETAILED DESCRIPTION OF PREFERRED EMBODIMENT

In all of the drawings, like reference numerals refer to like parts.

The figures show an apparatus 1 for collecting and containing fluid that has been extracted from a reservoir of fluid. The apparatus 1 includes a container 2, an inlet 3 into the container 2 for fluid from the reservoir of fluid, a tap 5 for controlling flow of the fluid through the inlet 3, an outlet 11 from the container 2 that is attachable to a vacuum gun 25, an outlet valve assembly 13, and a float valve assembly 60. The vacuum gun 25 is as described in the specification of WO 01/60671.

The outlet valve assembly 13 includes a valve seat 14, a valve member 15 and a coil spring 21 that biases the valve member 15 into engagement with the valve seat 14. Valve member 15 is moveable out of engagement with the valve seat 14 when a vacuum is being generated in the container 2 by the vacuum gun 25. An aperture 20 extends centrally through the valve seat 14. The valve member 15 has a sealing end 18 for sealing the aperture 20 and a valve stem 19 that extends from the sealing end 18.

The float valve assembly 60 includes a float valve member 16 for preventing the container 2 from overfilling with fluid. The float valve member 16 has a sealing end 34 and a buoyant sealed tubular body 35 extending from the sealing end 34. An O-ring located at the sealing end 34 seals the aperture 20 of the valve seat 14.

The container 2 includes a spherical body 40 and a ground-bearing stand 41 that extends from the body 40. Reinforcing ribs 42 (only some of which have been labelled) extend around the body 40 and prevent the body 40 from collapsing under negative pressure. A threaded inlet spout 44 extends from the body 40 and a threaded outlet spout 28 extends from an apical region of the body 40. A carry handle 43 extends from the body 40 adjacent the outlet spout 85.

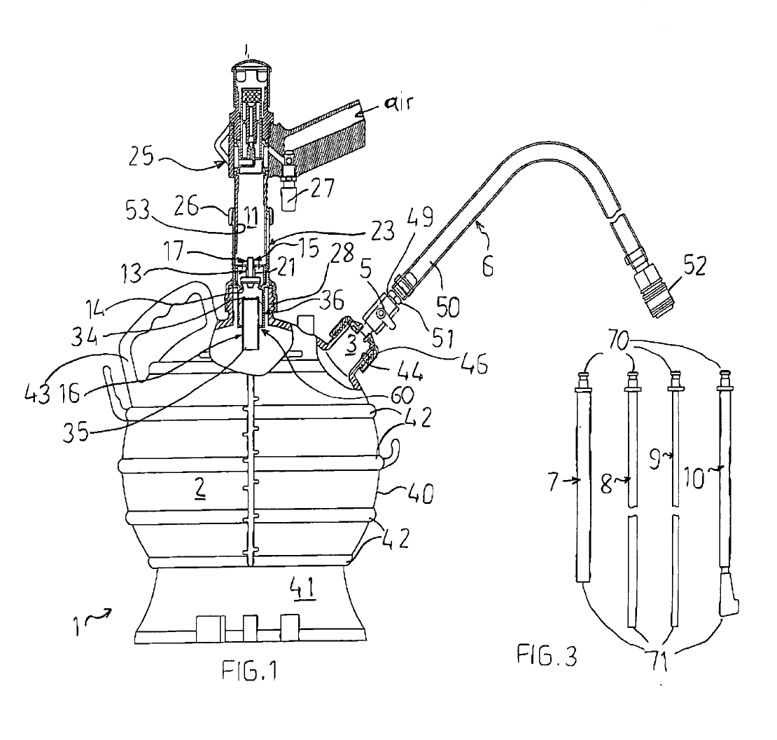

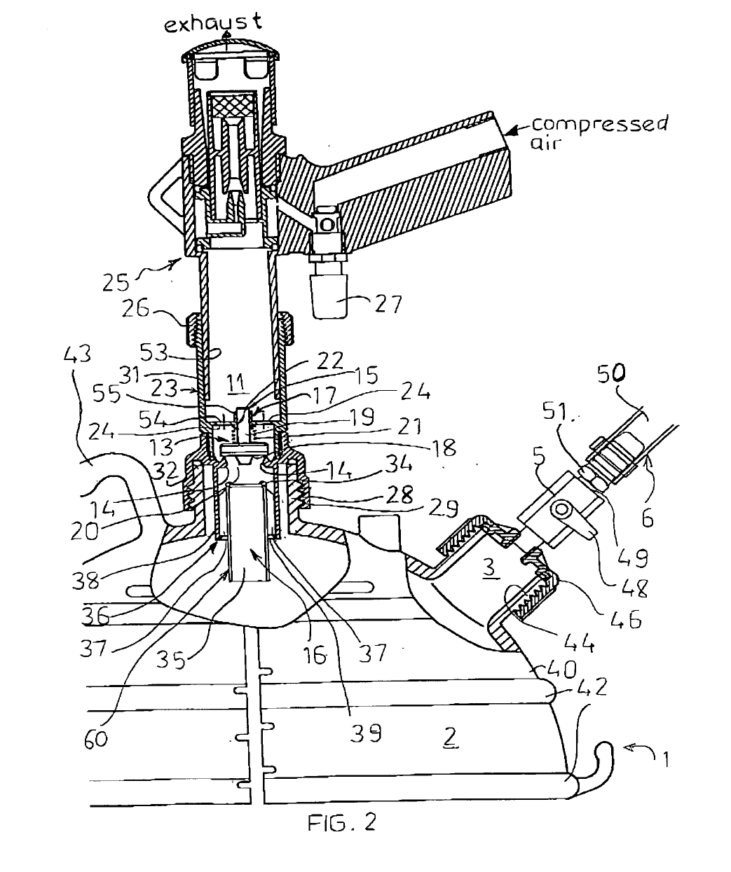

An outlet sleeve 23, comprising two sleeve pieces 31, 32 screwed to one another, is attached to the outlet spout 28. An end 29 of sleeve piece 32 is screwed onto the outlet spout 28. A free end of sleeve 23 provides the outlet 11 and is attachable to a barrel 53 of the vacuum gun 25, as shown in FIGS. 1 and 2. The barrel 53 frictionally engages the sleeve 23 and is held in place with a compression nut 26. The vacuum gun 25 is attachable to a source of compressed air (not shown) The gun 25 may be operated with trigger 27.

The outlet valve assembly 13 includes a guide 17 for guiding the valve member 15. The guide 17 is located within sleeve piece 31. The guide 17 comprises a perforated disk 54 and a sleeve 55 that extends perpendicularly from the disk 54. A plurality of apertures 24, including a centrally located aperture 22, extend through the disk 54. The valve stem 19 slidably extends through sleeve 55 and aperture 22. The coil spring 21 extends around the valve stem 19 and is located between the sealing end 18 and the guide 17.

The float valve assembly 60 includes a housing 36 for housing the float valve member 16 and for guiding it for movement relative to the valve seat 19. The housing 36 includes a cylindrical wall 38 that extends from a lower surface of the valve seat 19 and a circular clip 39 that extends from within a groove of the wall 38. The float valve member 16 has three fins 37 extending radially from an upper region of the buoyant body 35. Although a lower region of the buoyant body 35 may extend from the housing 36, the fins 37 are slidably retained within the wall 38 and between the valve seat 14 and the clip 39. When a vacuum is being generated in the spherical body 40 by the vacuum gun 25, then air located within the body 40 may be drawn between the clip 39 and the buoyant body 35 and further between the fins 37 and wall 38 to the valve seat 14. When the body 40 is filled with fluid, the float valve member 16 slides within the housing 36 towards the valve seat 14.

The inlet 3 is located at a free end of inlet spout 44. The tap 5 is rotatably mounted to a cap 46 and the cap 46 may be screwed onto inlet spout 44. The tap 5 has a handle 48 that may be turned to control the flow of fluid through the inlet 3.

As seen in the figures, different types of hose fittings 6 to 10 are attachable to the container 2 and may be used to extract a variety of fluids from vehicles and industrial machines. Referring now to FIGS. 1 and 2, fitting 6 comprises a hose 50 having a first end 51 that is attachable to an end 49 of the tap 5 and a second end 52 that is attachable to any one of fittings 7 to 10. In the embodiment of FIG. 1, fitting 6 has a quick coupler connection 52 for connecting to an end 70 of any one of fittings 7 to 10. Fitting 6 also has a check valve (not shown) for preventing fluid within the hose 50 from leaking out end 52.

The apparatus 1 may be used in one of two ways. When end 71 of any one of fittings 7 to 10 is placed in communication with the fluid reservoir and the tap 5 is opened and a constant vacuum is generated in the container 2 using the gun 25, then fluid may be sucked into the container 2 via the hose fittings 6-10. Alternatively, by generating a vacuum in the container 2 with the tap 5 closed, the container 2 may be used as a portable vacuum source. This is possible as valve member 15 only moves out of engagement with the valve seat 14 when a vacuum is being generated in the container 2. After pressurising the container 2, the container 2 may be transported to the reservoir of fluid for use, whereby the use involves placing fitting end 71 in communication with the reservoir of fluid and opening the tap 5.

The valve member 16 of the float valve assembly 60 prevents the container 2 from overfilling with fluid and contaminating the gun 25. The float valve member 16 rises with the rising level of fluid within the container 2. When fluid within the container 2 reaches a predetermined level, the sealing end 34 of the float valve member 16 seals against the valve seat 14 to cut off the vacuum.

When emptying the container 2 of fluid, cap 46 is removed and the fluid is poured through inlet spout 44. The tap 5 is rotatably mounted to the cap 46 so that the tap 5 and fittings will not twist when removing the cap 46.

We claim:

1. An apparatus for collecting and containing fluid from a reservoir of fluid, said apparatus having:
a container;
an inlet into the container for fluid from the reservoir of fluid;
an inlet valve operable between an open and a closed position for controlling flow of the fluid through the inlet;
an outlet from the container attachable to a vacuum pump for generating a vacuum within the container; and,
an outlet valve assembly including a valve seat and an outlet valve member biased into engagement with the valve seat and moveable out of engagement with the valve seat when a vacuum is being generated in the container by the vacuum pump.

2. The apparatus of claim 1, wherein the outlet valve member has a sealing end for engaging the valve seat and a valve stem extending from the sealing end.

3. The apparatus of claim 2, wherein the outlet valve assembly includes a guide for guiding the outlet valve member into and out of engagement with the valve seat.

4. The apparatus of claim 3, wherein the guide comprises a perforated disk and a guide sleeve extending perpendicularly from the disk, and the valve stem slidably extends through the guide sleeve.

5. The apparatus of claim 4, wherein the outlet valve member is biased into engagement with an upper surface of the valve seat by a coil spring that extends around the valve stem between the sealing end of the outlet valve member and the guide.

6. The apparatus of claim 1 further including a float valve assembly for closing the outlet when the container is full of the fluid.

7. The apparatus of claim 6, wherein the float valve assembly includes a float valve member having a sealing end engagable with a lower surface of the valve seat and a buoyant body extending from the sealing end of the float valve member towards a bottom of the container.

8. The apparatus of claim 7, wherein the float valve assembly includes a housing for guiding the float valve member for movement relative to the valve seat.

9. The apparatus of claim 8, wherein the housing extends from the lower surface of the valve seat, the float valve member has fins extending radially from an upper region of the buoyant body which are slidably retained within the housing, a lower region of the buoyant body extends through a lower end of the housing, and when a vacuum is being generated in the container by the vacuum pump, air located within the container is drawn through the lower end of the housing, between the fins and through the outlet.

10. The apparatus of claim 1, wherein the container has a spherical body for containing the reservoir fluid, reinforcing ribs extending around the body, and a ground-bearing stand extending from the body.

11. The apparatus of claim 10, wherein the container has an outlet spout extending from an apical region of the body and the outlet is located at a free end of the outlet spout.

12. The apparatus of claim 11 further including an outlet sleeve attachable to the outlet spout.

13. The apparatus of claim 10, wherein the outlet valve assembly is located within the outlet sleeve.

14. The apparatus of claim 10, wherein the container has an inlet spout extending from the body and the inlet is located at a free end of the inlet spout.

15. The apparatus of claim 14 further including a cap attachable to the inlet spout and the inlet valve comprises a tap rotatably mounted to the cap.

16. The apparatus of claim 1 further including a hose fitting attachable to the inlet valve.
